(19) United States
(12) Patent Application Publication
(10) Pub. No.: US 2008/0069727 A1
(43) Pub. Date: Mar. 20, 2008

(54) Semi-permanent skin adhering device for detecting biological conditions

(76) Inventors: William S. Yerazunis, Acton, MA (US); King T. Lau, Bettystown (IE); Roderick L. Shepherd, Donnybrook (IE); Karl H. Crowley, Larkhill (IE)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/521,185

(22) Filed: Sep. 14, 2006

(51) Int. Cl. G01N 31/22

(52) U.S. Cl. 422/56

(57) ABSTRACT

A device and method for detecting a biological condition. An adhesive layer is configured to be applied to skin of a user. A color-changing reagent being sensitive to a skin secretion of interest is held proximate to the skin in a semi-permanent manner by the adhesive layer. The color-changing reagent is indicative of a biological condition when in contact with the skin secretion.

### FIELD OF THE INVENTION

The invention relates generally to devices for detecting biological conditions, and more particularly devices that can adhered to skin in a semi-permanent manner.

### BACKGROUND OF THE INVENTION

### Biological Reagents

The use of color-changing, chemical reagents for indicating biological conditions is well known. For example, the reagent ninhydrin detects phenylketonuria (PKU) in infants. The reagent curcumin indicates amines. These reagents are typically used in vitro; that is, a biological sample is collected, separated from the individual, and placed in contact with the reagent. Alternatively, a temperature-sensing reagent such as a liquid crystal is embedded in a plastic laminated assembly, such as a card. The card is temporarily placed against the skin to indicate a temperature of the skin by a change in color. The color can indicate whether the person has a fever or not. As a characteristic, those reagents only indicate a biological condition at an instant in time.

### TATTOOS

Skin appliqués or “semi-permanent tattoos” are also well known. Typically, the appliqué includes dyes, an adhesive, and a substrate or backing for carrying the dyes and adhesive until they are applied. The appliqué is pressed against slightly moist skin. The adhesive adheres to the skin and the carrier backing, e.g., paper or a plastic film, is removed. After the dyes are applied, the colors do not change.

Typically, the tattoo remains in place in a semi-permanent manner for days, particularly if the adhesive is not soluble in water. The tattoo can be removed by a dissolving agent. The purpose of these skin appliqués is strictly decorative.

### SUMMARY OF THE INVENTION

The embodiments of the invention provide a device for detecting biological conditions of a user. The device is in the form of a skin appliqué. The appliqué contains an adhesive, a color-changing reagent, and a substrate or backing for carrying the adhesive and reagent until they are applied to the skin. As the skin

secretes various chemicals, such as different components of perspiration, the reagent reacts with the chemicals and changes color.

For example, the reagent can be curcumin, which is sensitive to ammonia emissions, to indicate extreme anerobic physical exertion. Reichardts dyes detect ketone emission, which is symptomatic of diabetes or alcohol consumption. Various reagents can indicate either normal or abnormal biological conditions.

### BRIEF DESCRIPTION OF THE DRAWINGS

FIG. 1 is an exploded view of a three layer device for detecting a biological condition according to an embodiment of the invention;

FIG. 2 is an exploded view of a two layer device for detecting a biological condition according to another embodiment of the invention;

FIG. 3 is an exploded view of a two layer device for detecting a biological condition according to another embodiment of the invention;

FIG. 4A is an exploded view of a one layer device for detecting a biological condition according to another embodiment of the invention with a symbol;

FIG. 4B is an exploded view of a one layer device for detecting a biological condition according to another embodiment of the invention with a symbol; and

FIG. 5 is an exploded view of a three layer device with multiple reagents for detecting a biological condition according to another embodiment of the invention;

### DETAILED DESCRIPTION OF THE PREFERRED EMBODIMENTS

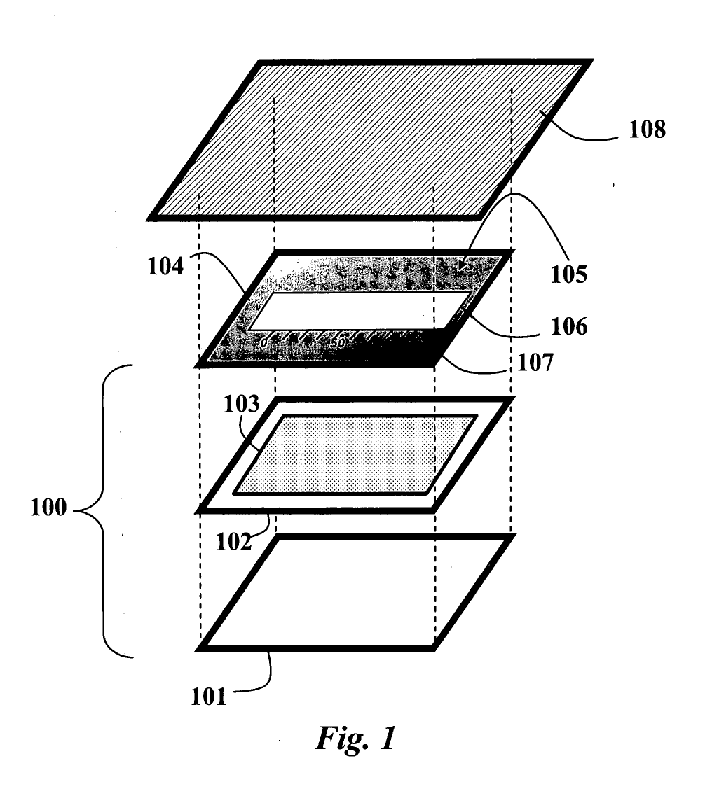

As shown in FIG. 1, an embodiment of the invention provides a device 100 for detecting biological conditions of a user. The device is in the form of a skin appliqué. The appliqué includes an adhesive and a color-changing reagent. The adhesive can hold the reagent in place in a semi-permanent manner, for example, for days or weeks. Typically, the adhesive and reagent are placed on a substrate or backing until they are transferred to the skin, at which time the backing is removed.

Device Structure

Adhesive Layer

A first adhesive layer 101, nearest to the skin, includes an adhesive. The adhesive is permeable to chemicals of interest secreted by the skin. The adhesive layer can be made impermeable to reagents. The adhesive can be water or oil soluble.

Reactive Layer

A second reactive layer 102, adjacent to a color-changing reagent 103. For example, the reagent can be curcumin. This reagent can indicate whether a user has achieved a sufficient intense peak workout levels, or not, by changing color from yellow to dark brown.

Other possible reagents include ninhydrin, phenanthroline, phenol red, copper(II) sulfate, methyl violet, thymol blue, methyl yellow, bromophenol blue, congo red, methyl orange, bromocresol green, methyl red, azolitmin, bromocresol purple, bromothymol blue, phenolphthalein, thymolphthalein, alizarin yellow, Reichert's dyes, chelated porphyrins, potassium permanganate, or other similar color-changing reagent.

The reagent 103 can also include an intermediate reagent to make the color-changing reagent sensitive to a skin secretion of interest. Optionally, the reactive layer 102 and/or the adhesive layer 101 can be semi-permeable to enable transit of the skin secretion of interest, yet prevent diffusion of the reagent 103 to the skin. This makes it possible to use reagents are normally not acceptable for direct contact with skin. The reagent may be a “composite” reagent, containing a mixture of two or more chemicals that together react to yield a color change in the presence of a skin secretion of interest.

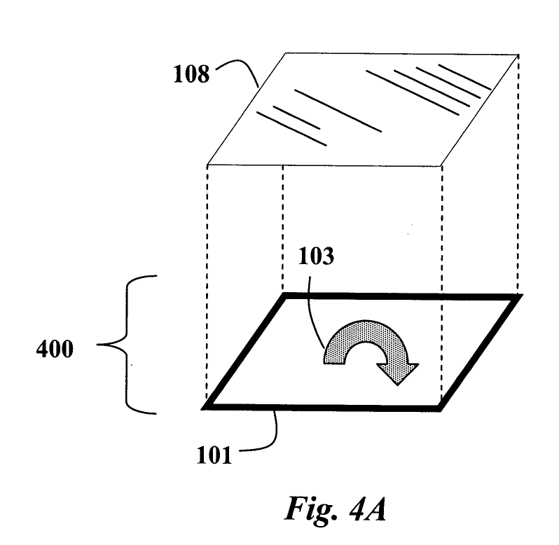

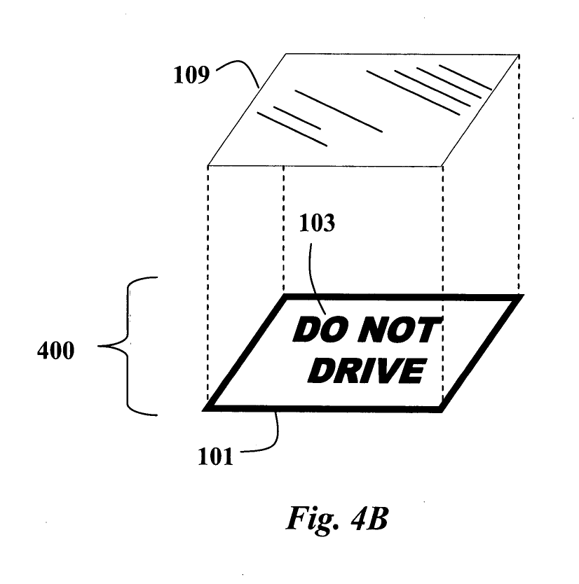

The reagent can be in the form of a pattern, a readily discernable symbol, or text that is easy to interpret by the user, see FIGS. 4A-4B. For example, a potassium permanganate reagent, which changes from purple to light yellow in the presence of ethyl alcohol, can show a message “DO NOT DRIVE.”

Reference Layer

A third reference layer 104, on the outside as applied to the skin, contains a colored area 105. The colored area provides reference colors. The third layer also includes a transparent or open and uncoated area, i.e., a window 106, to observer the color-changing reagent 103 of the reactive layer 102. The reference layer can be labeled, have a scale 107 or other indicia to identify particular colors of interest, i.e., biological conditions. Alternately, the color of the reference layer can initially be the same as the color of the reagent. Then, when the desired condition is detected, the color of the reagent becomes in contrast with the reference color. Alternatively, the reference color can initially be in contrast with the color of the reagent, and then the contrast fades as the condition is detected.

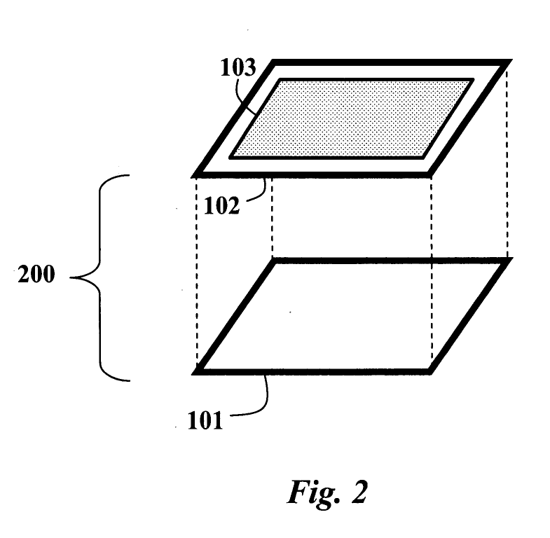

The primary purpose of the adhesive layer 101 is to hold the color-changing reagent 103 proximate to the skin in a semi-permanent manner. This purpose can be achieved by various other arrangements described below with reference to FIGS. 2-5.

The fourth layer 108 is an optional backing carrier layer, which is used only during manufacture and transportation, and is peeled away and discarded after the appliqué is transferred to the skin.

Typically, the above layers are laminated as adjacent layers during manufacture.

Device Operation

During operation, the first layer 101 adheres to the skin of the user in a semi-permanent manner. As the skin secretes various chemicals, the chemicals diffuse through the adhesive layer 101 to react with reagent 103 of the reactive layer 102. When the appropriate chemical diffuses into reagent 103, the reagent changes color. This color change is visible through window 106 of layer 105, which provides a color reference.

### Alternative Embodiments

Various layers can be omitted in alternative embodiments. For example, the color change is from one color to another single color only when a particular biological condition is detected. In this embodiment, the third reference layer 104 can be omitted, as shown in FIG. 2 for the device 200.

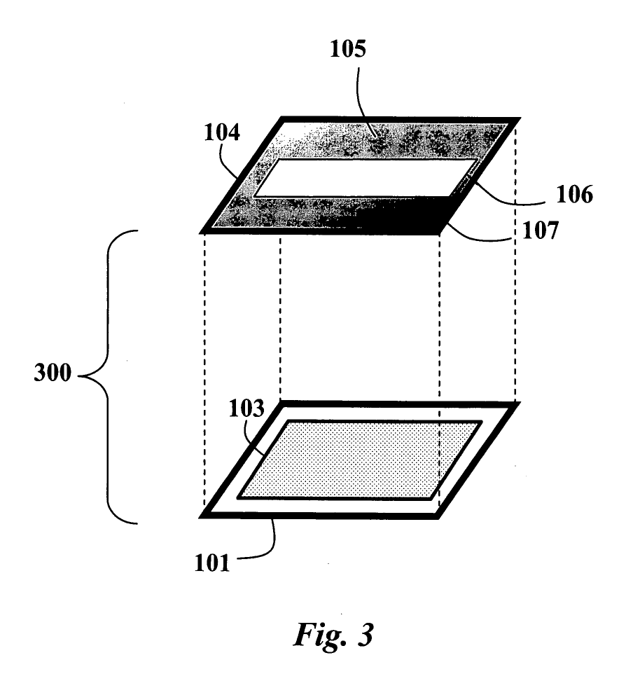

If there is no need to prevent diffusion of the color-changing reagent onto the skin, then the semi-permeable carrier layer 102 can be omitted and the reagent 103 can be applied directly on the adhesive layer 101, or mixed directly with the adhesive layer 101, as shown in FIG. 3 for the device 300.

As shown in FIGS. 4A-4B, the reagent 103 can mixed in with the adhesive layer 101 to produce a single layer device 400. In this case, the backing may not be necessary. The adhesive and reagent can be sprayed, painted, or rolled on with an appropriate applicator. Alternatively, an optional removable substrate backing 108 is used to transfer the adhesive and reagent to the skin.

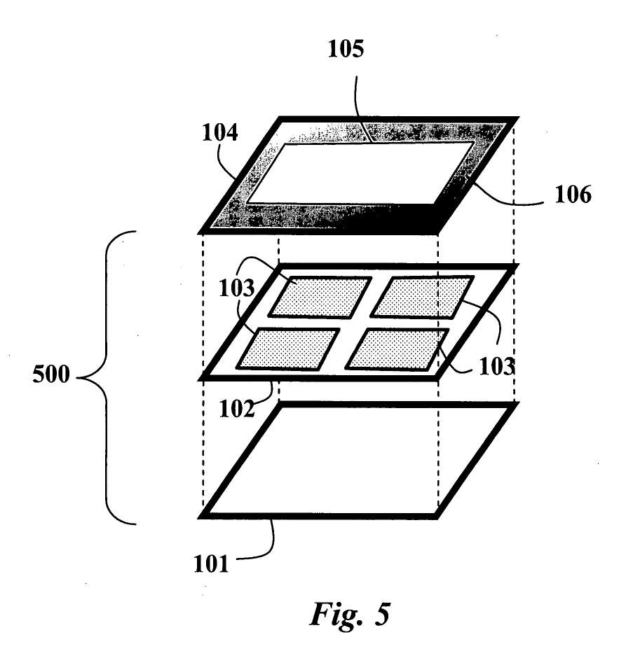

In cases where the reagent lacks a sufficient dynamic range to indicate a range of concentrations of the skin-secreted chemical of interest, multiple patches of reagents can be included in the device 500, as shown in FIG. 5. The patches can be related reagent formulations designed to change color at different concentrations of the skin-secreted chemical. That is, the patches have different sensitivity ranges. Alternatively, the patches can include multiple different reagents 103 to conduct concurrently multiple tests for different biological conditions.

Alternatively, the reagent 103 can be deposited in a gradient manner that provides a changing level of sensitivities across a desired range of sensitivity levels. Optionally, indicia can be used to indicate a color change at a particular point in the reagent gradient corresponds to particular levels of the skin-secreted chemical.

The embodiment of FIG. 5 can be combined with the arrangements of FIGS. 2, 3, and 4.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A device for detecting a biological condition, comprising:
an adhesive layer configured to be applied to skin of a user; and
a color-changing reagent sensitive to a skin secretion of interest, in which the adhesive layer holds the color-changing reagent proximate to the skin in a semi-permanent manner, and a color of the color-changing reagent is indicative of a biological condition when in contact with the skin secretion.

2. The device of claim 1, in which the adhesive layer is impermeable to the color-changing reagent.

3. The device of claim 1, in which the color-changing reagent is selected from a group consisting of curcumin, ninhydrin, phenanthroline, phenol red, copper(II) sulfate, methyl violet, thymol blue, methyl yellow, bromophenol blue, congo red, methyl orange, bromocresol green, methyl red, azolitmin, bromocresol purple, bromothymol blue, phenolphthalein, thymolphthalein, alizarin yellow, Reichert's dyes, chelated porphyrins, potassium permanganate, or other color-changing reagent.

4. The device of claim 1 in which the color-changing reagent forms a pattern.

5. The device of claim 1, in which the pattern is a symbol.

6. The device of claim 1, in which the pattern is text.

7. The device of claim 1, further comprising:
a reactive layer adjacent to the color-changing reagent.

8. The device of claim 1, further comprising:
a reference layer adjacent to the color-changing reagent, the reference layer containing reference colors, and in which the reference layer includes a transparent portion to observe the color-changing reagent.

9. The device of claim 8, in which the reference layer is labeled.

10. The device of claim 8, in which the reference colors are initially the same color as the color-changing reagent.

11. The device of claim 8, in which the reference colors are initially in contrast with the color of the color-changing reagent.

12. The device of claim 1, in which the color-changing reagent is in a form of multiple patches having different sensitivity ranges to the skin-secreted chemical of interest.

13. The device of claim 1, in which the color-changing reagent is deposited in a gradient having a continuously varying sensitivity range to the skin-secreted chemical of interest.

14. The device of claim 13, further comprising:
a reference layer adjacent to the color-changing reagent, the reference layer containing reference indicia, and in which the reference layer includes a transparent portion to observe the color-changing reagent.

15. The device of claim 1, in which the color-changing reagent is in a form of multiple patches, each patch being sensitive to a different skin-secreted chemical of interest and indicating a different biological conditions.

16. The device of claim 1, further comprising:
a substrate configured to transfer the adhesive and the color-changing adhesive to the skin.

17. A method for detecting a biological condition, comprising:
applying an adhesive to skin of a user; and
applying a color-changing reagent sensitive to a skin secretion of interest to the adhesive, in which the adhesive holds the color-changing reagent proximate to the skin in a semi-permanent manner, and the skin secretion is indicative of a biological condition.

18. The method of claim 17, in which the adhesive layer is impermeable to the color-changing reagent.

19. The method of claim 17, further comprising:
forming a pattern with the color-changing reagent.

20. The method of claim 17, further comprising:
applying a reference layer containing reference colors to the color-changing reagent, and in which the reference layer includes a transparent portion to observer the color-changing reagent.

21. The method of claim 17, in which the color-changing reagent is in a form of multiple patches having different sensitivity ranges to the skin-secreted chemical of interest.

22. The method of claim 17, in which the color-changing reagent is in the form of a continuous gradient of varying sensitivity to the skin-secreted chemical of interest.

23. The method of claim 17, in which the color-changing reagent is in a form of multiple patches, each patch being sensitive to a different skin-secreted chemical of interest.
